(19) United States
(12) Patent Application Publication
(10) Pub. No.: US 2006/0254959 A1
(43) Pub. Date: Nov. 16, 2006

(54) Air sifting apparatus having variable air supply

(75) Inventor: Heribert Breuer, Kempen (DE)

Correspondence Address: ROBERT W. BECKER & ASSOCIATES, Suite B, 707 State Highway 333, Tijeras, NM, 87059-7507, US

(73) Assignee: allmineral Aufbereitungstechnik GmbH & Co. KG, Duisburg (DE)

(21) Appl. No.: 11/432,571

(22) Filed: May 11, 2006

(30) Foreign Application Priority Data
May 11, 2005 (DE) 20 2005 007 472.1

(51) Int. Cl. B07B 9/00

(52) U.S. Cl. 209/21

(57) ABSTRACT

An air sifting apparatus for dry preparation of material comprising an apertured sifted material carrier for receiving material from a material feed device. An air plenum is disposed below the carrier and is comprised of two chambers that are separated from one another and are disposed one after the other in the direction in which the material is conveyed by the carrier. Each chamber has an air inlet for receiving a constant partial air stream. Respective inlet conduits deliver a pulsating air stream to each chamber. The air plenum supplies an air stream that flows through the carrier to loosen and layer the material received thereby into a heavy material layer and a light material layer disposed on the heavy material layer. The air stream is composed of the constant partial air stream and the pulsating air stream.

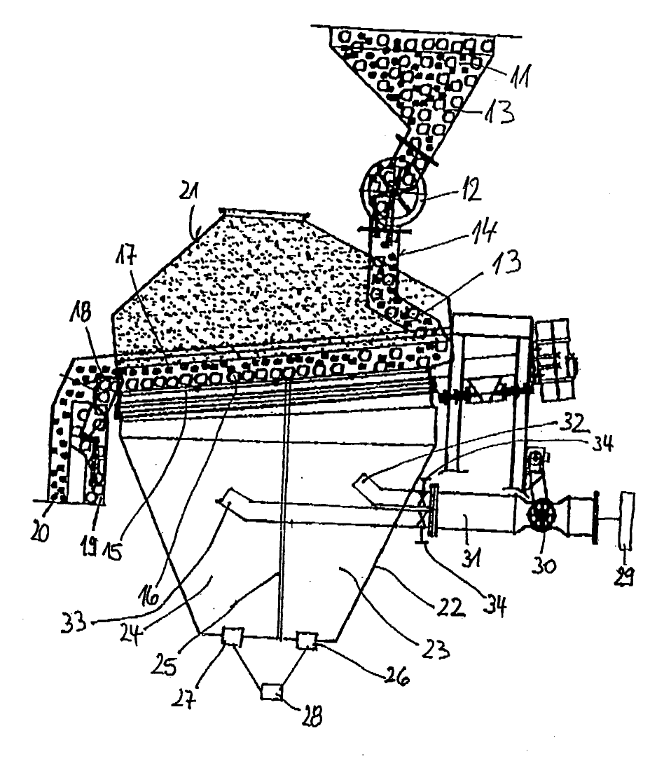

The instant application should be granted the priority date of May 11, 2005, the filing date of the corresponding German patent application 20 2005 007 472.1.

### BACKGROUND OF THE INVENTION

The present invention relates to an air sifting apparatus for dry preparation of raw material, especially coal. The apparatus includes a material feed device, and an apertured sifted material carrier for receiving material from the feed device. Respective discharge means are provided for receiving the heavy material and the light material that are layered on the sifted material carrier during the process. To loosen or break up and layer the material that is received on the sifted material carrier into a heavy material layer, which acts as a sifting bed, and into a light material layer that is disposed thereon, an air stream, which is supplied by an air plenum disposed below the sifted material carrier, can flow through the carrier. This air stream is composed of a partial stream that constantly flows through the sifted material carrier, and a pulsating air stream that is introduced into the air plenum.

An air sifting apparatus of this general type is described in U.S. Pat. No. 6,467,631 B2. The material that is to be prepared is supplied via a material feed device, for example a star gate feeder, to the sifted material carrier, which is embodied as an apertured plate or a wire mesh. By means of an air plenum that is disposed below the sifted material carrier, an air stream is conveyed that is comprised of a partial stream that constantly flows through the carrier, and a pulsating partial stream that overlaps the constant partial stream. By supplying the sifted material carrier, with the material that is to be prepared disposed thereon, with the constant air stream, a basic fluidization of the material that is disposed on the sifted material carrier is achieved, so that thereby a to some extent permanent loosening of the material is achieved that initially has a relatively low pressure loss during the vertical flow of air through the sifted material carrier. Thus, with respect to the overlappingly introduced pulsating air stream, only a relatively low flow rate of pulsating air is required in order, within the framework of the course of the process imminent with a sifting apparatus, to periodically raise and lower the material bed that is disposed on the sifted material carrier and to thereby bring about the layering of the material.

The known air sifting apparatus has the drawback that the layering, rather than being uniformly maintained, varies in its buildup for the lengthwise stretch of the sifted material carrier as viewed in the direction in which the material is conveyed. This is the case because as the retention time of the material on the sifted material carrier increases, namely on the sifting bed that is formed on the carrier, different resistances are created for the air stream that is passing through. This drawback becomes all the more greater the more non-homogeneously the material that is to be prepared is composed. Thus, the separation result is not optimally possible with the known apparatus.

It is therefore an object of the present invention to further improve the separation result of an air sifting apparatus of the aforementioned general type.

### BRIEF DESCRIPTION OF THE DRAWING

This object, and other objects and advantages of the present invention, will appear more clearly from the following specification in conjunction with the sole FIGURE of the drawing, which is a schematic side view of one exemplary embodiment of an air sifting apparatus of the present application.

### SUMMARY OF THE INVENTION

The air sifting apparatus of the present application comprises an air plenum that is disposed below the sifted material carrier and is comprised of two chambers that are separated from one another and are disposed one after the other in a direction in which the material is conveyed by the sifted material carrier. Each of the chambers is provided with an air inlet for receiving a constant partial air stream. Respective air inlet conduits are provided for delivering a pulsating air stream to each of the chambers, wherein the air plenum is adapted to supply an air stream to the sifted material carrier such that the air stream flows through the carrier to loosen and layer the material received thereby into a heavy material layer, which acts as a sifting bed, and a light material layer, which is disposed on the heavy material layer. The air stream is composed of the constant partial air stream and the pulsating air stream.

The air sifting apparatus of the present application has the advantage that by forming two chambers in the air plenum, each having different air inlets for the constant partial stream and for the pulsating partial stream, differing air supplies can be achieved over the retention stretch of the material upon the sifted material carrier, and in particular not only for the constant partial stream but also for the pulsating partial stream. Thus, the overall stream can be adapted to the composition of the material that is to be prepared, and the air stream can also be adapted to differing sifting bed conditions that result over the length of the sifted material carrier.

Pursuant to one embodiment of the present invention, the two air inlets for the two chambers have adjustable air inlet cross-sections to regulate the respective constant partial streams that enter the chambers.

If pursuant to a first embodiment of the present invention the pressure of the pulsating partial stream that is introduced into the first chamber, which follows the material feed, is greater than the pressure of the pulsating partial stream in the second chamber of the air plenum that follows the first chamber, it is possible to thereby improve the vertical loosening of material that is difficult to prepare, so that the pulsating partial stream that is necessary for the layering of the material is better applied.

However, depending upon the material that is to be prepared it is alternatively also possible for the pressure of the pulsating partial stream that is introduced into the first chamber, which follows the material feed, to be less than the pressure of the pulsating partial stream in the second chamber of the air plenum that follows the first chamber.

If pursuant to a first embodiment of the invention the two inlet conduits that are associated with the two chambers open into a collecting conduit that is connected to a common air flow generator for the pulsating partial stream, with the movement of the sifting bed on the sifted material carrier over the length of the carrier, and hence of the sifting bed that is being layered, the frequency of the up and down movement of the sifting bed is the same.

Alternatively, however, it is also possible for each inlet conduit to have a separate air flow generator to achieve different pulse frequencies for the pulsating partial streams that enter the chambers, so that over the length of the sifting material carrier different sifting bed movements are achieved in the regions of the sifted material carrier that are disposed over the two chambers of the air plenum.

With regard to the ratio of constant partial stream to pulsating partial stream, the pressure of the pulsating partial stream in each chamber can be the same or, alternatively, greater than the pressure of the constant partial stream.

Pursuant to an embodiment of the invention, in each chamber the flow rate of the pulsating partial stream is less than the flow rate of the constant partial stream.

Further specific features of the present application will be described in detail subsequently.

### DESCRIPTION OF SPECIFIC EMBODIMENTS

Referring now to the drawing in detail, the illustrated air sifting apparatus is provided with a feed funnel 11 that opens into a star gate feeder 12, so that the material 13 that is introduced into the feed funnel 11, and which is to be separated into light material and heavy material, is conveyed by the star gate feeder 12 as fed material into the angular feed chute 14. The feed chute 14 ends at one end of a sifted material carrier or bed support device 15 that is mounted in the air sifting apparatus at an incline. As a consequence of the movement kinematics, which will be described in detail subsequently, the material 13 that is supplied is stratified or arranged in layers during the course of its transport, and over the length of the carrier or device 15, namely into a heavy material layer 16 and a light material layer 17 that is formed thereabove.

Provided at the rear end of the sifted material carrier 15, opposite the feed chute 14, is a discharge device 18 that is in the form of a weir and that separates the heavy material layer 16 from the light material layer 17 in such a way that the heavy material layer 16 is conveyed into a first discharge chute 19 while the light material layer 17 passes beyond the weir 18 into the discharge chute 20 for the light material.

The air sifting apparatus is closed off outwardly by a housing 21 that rises above the sifted material carrier 15, so that dust that might result during the dry preparation cannot pass into the atmosphere. Thus, such an air sifting apparatus keeps any environmental pollution low.

Disposed below the sifted material carrier 15 is an air plenum 22 via which the air that is required for carrying out the sifting movement is conveyed from below to the sifted material carrier 15, which is formed as an apertured plate or as a wire mesh. The air plenum 22 is divided by a partition 25 into two chambers 23 and 24 that are separated from one another. A first one of the chambers 23 is adjacent to the feed chute 14, and the second chamber 24 follows the first chamber 23 in the direction in which the material is conveyed by the sifted material carrier 15.

Each of the two separated chambers 23 and 24 is provided at its lower end with an air inlet 26 or 27 respectively. Each of these two air inlets 26 and 27 is connected to a first air flow generator 28, which generates a constant air stream having a constant pressure and volume. This air stream is conveyed into the two chambers 23, 24 via the air inlets 26 and 27, so that the constant air stream that is present in the respective chamber 23, 24 continuously flows through that region of the sifted material carrier 15 that is disposed above the chambers from below. The two air inlets 26 and 27 are respectively provided with adjustable air inlet cross-sections, so that the constant partial air stream that is conveyed into the associated chamber 23 or 24 can have its volume adjusted for each chamber.

In the illustrated embodiment, a second air flow generator 29 is disposed to the side of the air plenum 22. The second air flow generator 29 is provided for supplying a pulsating partial stream that overlaps the constant partial stream generated by the first air flow generator 28. This is effected in that the air stream that is produced by the second air flow generator 29 is guided by a rotary valve 30 that brings about the pulsation of the air stream that is generated by the second air flow generator 29. Following the rotary valve 30 is a collecting conduit 31 for receiving the pulsating air stream. The collecting conduit 31 is divided into two inlet conduits 32 and 33 for each of the two chamber 23 and 24 respectively. Inserted in each of the two inlet conduits 32, 33 is a valve 34 for adjusting the partial stream that is to be supplied. In this way, each of the individual chambers 23 and 24 receives a partial air stream of the pulsating air stream that is generated.

Although not illustrated, to generate different pulsations of the partial streams that are to be conveyed into the two chambers 23 and 24 separate air flow generators can be provided that are respectively connected to the associated chamber.

The features of the subject matter disclosed in the specification, the claims and the drawing can be important individually as well as in any desired combination with one another for realizing the various embodiments of the invention.

The specification incorporates by reference the disclosure of German priority document 20 2005 007 472.1 filed May 11, 2005.

The present invention is, of course, in no way restricted to the specific disclosure of the specification and drawing, but also encompasses any modifications within the scope of the appended claims.

What I claim is:

1. An air sifting apparatus for dry preparation of material composed of heavy material and light material, comprising:
a material feed device;
an apertured sifted material carrier for receiving material from said material feed device;
respective discharge means for receiving a heavy material layer and a light material layer from said sifted material carrier;
an air plenum disposed below said sifted material carrier and comprised of two chambers that are separated from one another and are disposed one after the other in the direction in which the material is conveyed by said sifted material carrier, wherein each of said chambers is provided with an air inlet for receiving a constant partial air stream; and
respective inlet conduits for delivering a pulsating air stream to each of said chambers, wherein said air plenum is adapted to supply an air stream to said sifted material carrier such that said air stream flows through said sifted material carrier to loosen and layer the material received by said sifted material carrier into said heavy material layer, which acts as a sifting bed, and said light material layer, which is disposed on said heavy material layer, and wherein said air stream is composed of said constant partial air stream and said pulsating air stream.

2. An air sifting apparatus according to claim 1, wherein said air inlets of said two chambers are each provided with adjustable air inlet cross-sections to regulate the respective constant partial stream that enters said chambers.

3. An air sifting apparatus according to claim 1, wherein a pressure of said pulsating air stream that is delivered into a first one of said chambers, which follows said material feed device, is greater than a pressure of said pulsating partial stream in a second one of said chambers that follows said first chamber.

4. An air sifting apparatus according to claim 1, wherein a pressure of said pulsating air stream that is delivered into a first one of said chambers, which follows said material feed device, is less than a pressure of said pulsating air stream in a second one of said chambers that follows said first chamber.

5. An air sifting apparatus according to claim 1, wherein said inlet conduits that are associated with said two chambers open into a collecting conduit that is connected to a common air flow generator for said pulsating air stream.

6. An air sifting apparatus according to claim 1, wherein each of said inlet conduits is associated with a separate air flow generator for achieving different pulse frequencies for said pulsating air streams that are delivered to said chambers.

7. An air sifting apparatus according to claim 1, wherein in each of said chambers the pressure of said pulsating air stream is adapted to be the same as the pressure of said constant partial air stream.

8. An air sifting apparatus according to claim 1, wherein in each of said chambers the pressure of said pulsating air stream is adapted to be greater than the pressure of said constant partial air stream.

9. An air sifting apparatus according to claim 1, wherein in each of said chambers a flow rate of said pulsating air stream is adapted to be less than a flow rate of said constant partial air stream.
